(19) United States
(12) Patent Application Publication
(10) Pub. No.: US 2020/0302880 A1
(43) Pub. Date: Sep. 24, 2020

(54) ELECTRONIC DEVICE

(71) Applicant: KYOCERA Corporation, Kyoto-shi, Kyoto (JP)

(72) Inventor: Yuto ISHIDA, Kawanishi-shi, Hyogo (JP)

(21) Appl. No.: 16/088,080

(22) PCT Filed: Mar. 9, 2017
(86) PCT No.: PCT/JP2017/009384

§ 371 Date: Sep. 25, 2018

(30) Foreign Application Priority Data
Mar. 29, 2016 (JP) 2016-066405

(51) Int. Cl. G09G 3/34; G04C 10/02; G04G 9/00; H04M 1/02; H04W 52/02

(52) U.S. Cl. CPC G09G 3/3406; G04C 10/02; G09G 2360/144; H04M 1/0266; H04W 52/0251; G04G 9/0064

(57) ABSTRACT

An electronic device comprises a rechargeable battery, a display, and a power generation unit. The display can display a screen and change luminance of the screen. The power generation unit generates electrical power upon receiving solar light. The display includes a first light emitting unit to which electrical power is supplied from the power generation unit to emit light and a second light emitting unit to which electrical power is supplied from the battery to emit light. The display changes a screen to be bright when the electrical power supplied from the power generation unit becomes large, and darken the screen when the electrical power supplied from the power generation unit becomes small.

### CROSS-REFERENCE TO RELATED APPLICATION

The present application is a National Phase entry of PCT Application No. PCT/JP2017/009384 filed on Mar. 9, 2017, which claims the benefit of Japanese Application No. 2016-066405, filed on Mar. 29, 2016. PCT Application No. PCT/JP2017/009384 is entitled “ELECTRONIC DEVICE”, and Japanese Application No. 2016-066405 is entitled “ELECTRONIC DEVICE”.

### TECHNICAL FIELD

Embodiments of the present disclosure relate to an electronic device.

### BACKGROUND ART

Conventionally, there are mobile communication devices generating electrical power upon receiving solar light.

### SUMMARY

An electronic device according to one embodiment comprises a rechargeable battery, a display, and a power generation unit. The display can display a screen and change luminance of the screen. The power generation unit generates electrical power upon receiving solar light. The display includes a first light emitting unit to which electrical power is supplied from the power generation unit to emit light and a second light emitting unit to which electrical power is supplied from the battery to emit light. The display changes a screen to be bright when the electrical power supplied from the power generation unit becomes large, and darken the screen when the electrical power supplied from the power generation unit becomes small.

### BRIEF DESCRIPTION OF DRAWINGS

FIG. 1 An appearance diagram of a smartphone according to an embodiment viewed from one direction.

FIG. 2 A block diagram showing a function configuration of the smartphone according to an embodiment.

FIG. 3 A diagram showing a structure around a display and a touch panel of the smartphone according to an embodiment.

FIG. 4 A circuit diagram of a power supply system of a backlight of the smartphone according to an embodiment.

FIG. 5 An appearance diagram of the smartphone according to an embodiment viewed from one direction.

FIG. 6 A block diagram showing a function configuration of the smartphone according to an embodiment.

FIG. 7 A diagram showing a state where solar light enters at right angle with a surface including a display of the smartphone according to an embodiment.

FIG. 8 A diagram showing a state where solar light obliquely enters the surface including the display of the smartphone according to an embodiment.

FIG. 9 An appearance diagram of one example of a terminal according to an embodiment.

FIG. 10 An appearance diagram of one example of a terminal according to an embodiment.

FIG. 11 An appearance diagram of one example of a terminal according to an embodiment.

FIG. 12 One example of a display of a screen according to an embodiment.

FIG. 13 A flow chart showing a flow of processing according to an embodiment.

### DESCRIPTION OF EMBODIMENT(S)

Embodiments for implementing an electronic device, a control method, and a control program are described in detail with reference to drawings. A smartphone 1 is described as one example of the electronic device hereinafter.

### First Embodiment

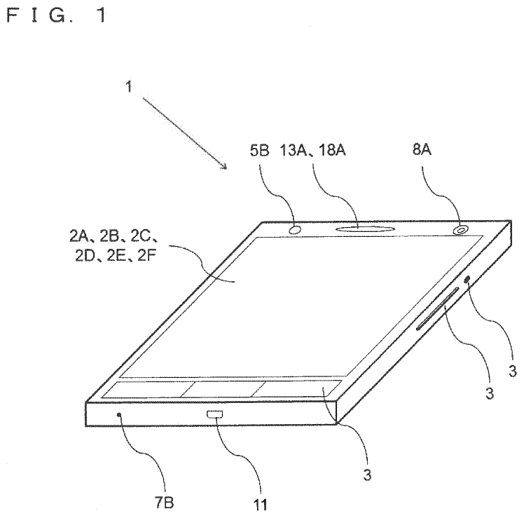

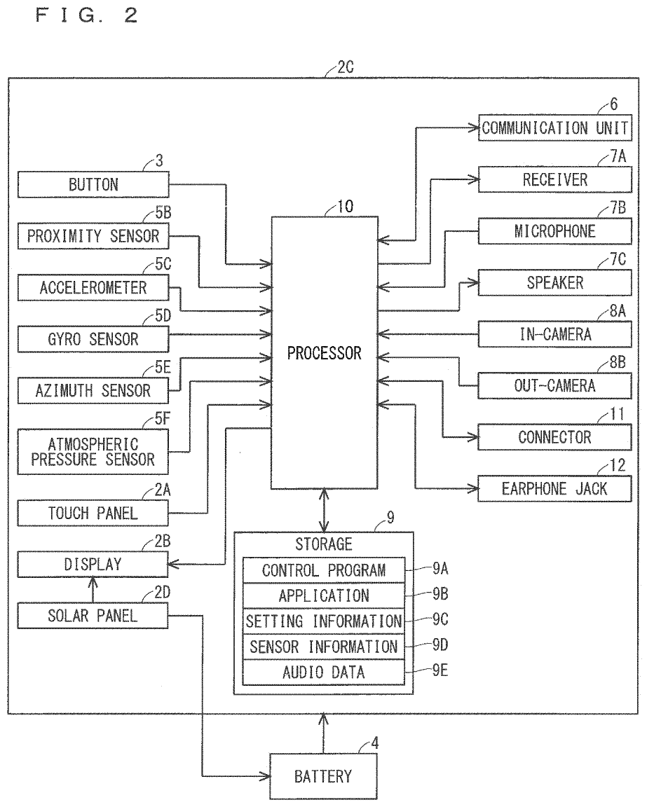

One example of the smartphone 1 according to one embodiment is described with reference to FIGS. 1 and 2. FIG. 1 is an appearance diagram of one example of the smartphone 1. FIG. 2 is a block diagram of one example of a function configuration of the smartphone 1. The smartphone 1 comprises a touch panel 2A, a display 2B, a housing 2C, a solar panel 2D, a protection panel 2E which is a type of a screen panel, a button 3, a battery 4, a proximity sensor 5B, an accelerometer 5C, a gyro sensor 5D, an azimuth sensor 5E, an atmospheric pressure sensor 5F, a communication unit 6, a receiver 7A, a microphone 7B, a speaker 7C, an in-camera 8A, an out-camera 8B, a storage 9, a processor 10, a connector 11, and an earphone jack 12.

In the present disclosure, an upper part of the smartphone 1 indicates a back side of a paper sheet of FIG. 1 and a lower part of the smartphone 1 indicates a near side of the paper sheet of FIG. 1. In the smartphone 1, a surface comprising the touch panel 2A, the display 2B, and the solar panel 2D shown in FIG. 1 is referred to as a front surface, and a surface located on an opposite side of the front surface is referred to as a back surface.

A touch panel of electrostatic capacitance type, electromagnetic induction type, surface acoustic wave type, pressure sensitive type, liquid resistance film type, and infrared type, for example, is arbitrarily applied to the touch panel 2A. The touch panel 2A can detect a contact and proximity of a finger or a stylus pen, for example. Accordingly, the touch panel 2A can identify an operation performed by a user on the smartphone 1 and transmit a result of the identification to the processor 10.

The display 2B can display an image. The user can confirm a state of a terminal based on a display of the display 2B. A display device such as a liquid crystal display, an organic EL display, a non-organic EL display, or an electronic paper, for example, may be used for the display 2B. The smartphone 1 comprising a liquid crystal display as the display 2B is described as one example in one embodiment. The liquid crystal display includes a backlight LED (light emitting diode) 2F for improving visibility, and is illuminated brightly. Luminance of a screen is controlled by emission intensity of the LED 2F. The emission intensity of the LED 2F may be controlled based on a setting performed by a user, or also may be controlled based on signals of various sensors. In one embodiment, the backlight LED 2F indicates a group of a plurality of LEDs. The LED 2F includes the LED receiving a power supply from the battery 4 described below and the LED receiving a power supply from the solar panel 2D described below. In one embodiment, the backlight LED 2F is integrated with the liquid crystal display, however, the back light LED 2F may be formed separately from the liquid crystal display.

In one embodiment, the touch panel 2A and the display 2B are disposed to overlap with each other. However, the touch panel 2A and the display 2B may be located in separate positions. The touch panel 2A and the display 2B may have an area different from each other. A plurality of touch panels 2A and a plurality of displays 2B may also be provided. An in-cell type display having both an input function and a display function may be used as the touch panel 2A and the display 2B. The protection panel 2E protects the touch panel 2A and the display 2B. A screen panel such as panel made up of a chemical strengthened glass or a sapphire panel is used for the protection panel 2E. A material of the protection panel 2E may be a transparent resin, or the other material may also be applicable.

The housing 2C is formed of a resin material in one embodiment. The housing 2C comprises a front surface panel and a back surface panel joined to each other. The front surface panel is a member constituting a front surface of the smartphone 1, and the back surface panel is a member constituting a back surface of the smartphone 1. The housing 2C may be made of various types of materials such as a metal, or may also be made of plural different materials. The housing 2C may be made up of not a combination of the front surface panel and the back surface panel but one member. The housing 2C may be made up of not the two members of the front surface panel and the back surface panel but a combination of three or more members. The protection panel 2E may be considered to be included in the housing 2C.

When the button 3 is pressed, the button 3 can receive various inputs from the user. The button 3 receives a shutdown operation of turning off a power source of the smartphone 1 or a boot operation of turning on the power source, for example. The button 3 receives an operation of switching to a sleep mode, an operation of releasing the sleep mode, or a volume control operation, for example. The button 3 may be either single or plural. The button 3 may be a physical key using a task switch or a membrane switch or a soft key provided by using part of the touch panel 2A. The button 3 may have a structure of detecting an input via the electrostatic capacitance or the pressure sensitivity.

The battery 4 is used as a power source for supplying electrical power to various units of the smartphone 1. The battery 4 may be charged by electrical power supplied from a connector 11, or may be charged by the solar panel 2D.

A proximity sensor of electrostatic capacitance type, ultrasonic type, photoelectric type, magnetic type, or induction type, for example, is arbitrarily applied to the proximity sensor 5B. The proximity sensor 5B can detect proximity of an object to the proximity sensor 5B.

The accelerometer 5C can detect a direction and a magnitude of acceleration acting on the smartphone 1.

The gyro sensor 5D can detect an angular speed of the smartphone 1.

The azimuth sensor 5E can detect a direction of earth magnetism. The azimuth sensor 5E can detect an azimuth direction in which the smartphone 1 is oriented.

The atmospheric pressure sensor 5F can detect an atmospheric pressure acting on the smartphone 1. The smartphone 1 can specify a change of posture and position of the smartphone 1 by using one or some of the accelerometer 5C, the gyro sensor 5D, the azimuth sensor 5E, and the atmospheric pressure sensor 5F.

The communication unit 6 comprises a circuit to convert a signal for communication and an antenna to transmit and receive the signal. A communication standard used by the communication unit 6 is a wireless communication, for example. The communication standard includes, for example, 2G, 3G, LTE (Long Term Evolution), 4G, WiMAX® (Worldwide Interoperability for Microwave Access), Bluetooth®, IEEE 802.11, NFC (Near Field Communication), IrDA (Infrared Data Association), and Zigbee®. The communication standard is not limited thereto, however, various wireless communication systems are included. The communication unit 6 functions as a communication unit in the smartphone 1. The communication unit 6 can use Internet communication, thereby obtaining various types of information including weather information and date and time information. When the communication unit has a communication function of a communication system such as 3G or LTE, the smartphone 1 can estimate position information based on a base station to which the communication unit is connected.

The receiver 7A can output sound. The receiver 7A is used to output audio when the user talks with the smartphone 1, which is held by the user in his/her hand, being in contact with his/her ear. The receiver 7A can output the sound based on audio data including various audios such as a music, an alarm, and a notification sound.

The speaker 7C can output sound. The speaker 7C can output the sound based on audio data including various audios such as mainly a video, a music, and an alarm by vibrating a vibration plate. The speaker 7C is also used for outputting a voice of a call of the other party during a hands-free call. A sound volume which the speaker 7C can output is normally larger than that of the receiver 7A. The speaker 7C is located on a side of the back surface panel in one embodiment. The speaker 7C may be located on a side of the front surface panel, or may also be located on a side of the side surface of the smartphone 1. That is to say, the speaker 7C may be located in any surface of the smartphone 1. The speaker 7C may be provided in the protection panel 2E protecting the display 2B and the touch panel 2A. The smartphone 1 may comprise the plurality of speakers 7C.

The smartphone 1 may comprise only one of the receiver 7A and the speaker 7C. In this case, one of the receiver 7A or the speaker 7C of the smartphone 1 may double as other's function.

The microphone 7B can convert a voice of the user and a surrounding environmental sound, for example, into a sound signal. The plurality of microphones 7B may be provided in various parts of the housing 2C.

The in-camera 8A and the out-camera 8B can convert a taken image into an electrical signal. The in-camera 8A is located in a surface including the display 2B in the smartphone 1, and the out-camera 8B is located in a surface opposite to the side of the in-camera 8A.

The storage 9 is made up of a storage medium such as a flash memory, an HDD, a SSD, a memory card, an optical disk, a magnetic optical disk, or a RAM, for example. The storage 9 can store a program and data. The storage 9 may be made up of a combination of a plural types of storage mediums. The storage 9 may include a storage medium and a reading device to read out information from the storage medium.

The program stored in the storage 9 includes a control program 9A which controls an operation of the smartphone 1 and an application 9B. The control program 9A includes OS, for example. The application 9B is executed in a foreground when an input to an icon corresponding to the application 9B is received, and the display 2B displays a screen which enables an operation on the application 9B. The application 9B may also be executed in a background. The application 9B also includes an application installed by the user. The data stored in the storage 9 includes various types of setting information 9C, sensor information 9D including history information of signals transmitted from the various sensors, for example, a result determined from the sensor information 9D, and audio data 9E, for example.

The processor 10 is one example of a controller. The smartphone 1 includes at least one processor 10 and provides a control and a processing capacity to achieve various functions described below. In accordance with various embodiments, the at least one processor 10 may be implemented as a single integrated circuit (IC) or as multiple communicatively coupled IC's and/or discrete circuits. The at least one processor 10 can be achieved by various known techniques. In one embodiment, the processor 10 includes one or more circuits or units configured to perform one or more data computing procedures or processes by executing instructions stored in an associated memory, for example. In the other embodiment, the processor 10 may be firmware configured to execute one or more data computing procedures or processes (a discrete logic component, for example). In accordance with various embodiments, the processor 10 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described hereinafter.

The processor 10 includes a determination unit and a hand-off unit. In some embodiments, the determination unit and the hand-off unit are achieved as executable commands stored in the memory, and a processing circuit included in the processor 10 executes the commands. The determination unit and the hand-off unit execute each process described in the present disclosure. In another embodiment, the determination unit and/or the hand-off unit may be achieved by a separate IC's or a discrete circuit communicatively coupled to the processor to achieve each function described in the present disclosure. The processor 10 executes the application 9B and the control program 9A. The processor 10 totally controls the operation of the smartphone 1 to achieve the various functions.

The smartphone 1 may include a GPS (Global Positioning System) receiver and a vibrator in addition to the above function units. The processor 10 can use a signal from a GPS satellite received by the GPS receiver to detect a current position of the smartphone 1. Accordingly, not only the communication unit but also the processor 10 has a function as the position information acquisition unit.

The vibrator has an eccentric motor or a piezoelectric element, for example. The vibrator vibrates the whole smartphone 1, thereby transmitting a notification to the user, for example.

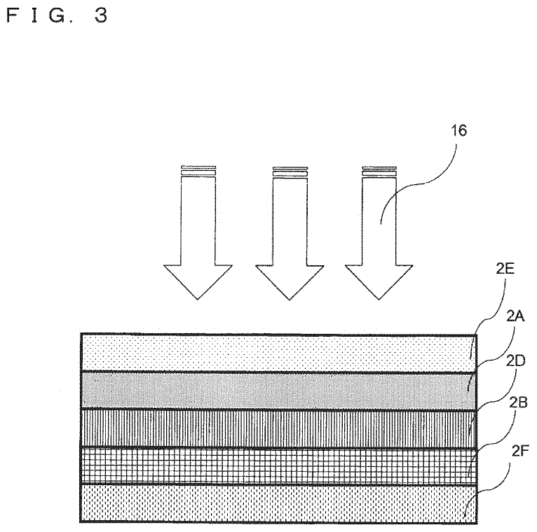

In addition to the above configuration, the smartphone 1 comprises the solar panel 2D. The solar panel 2D can generate electrical power upon receiving light. In one embodiment, the solar panel 2D is located between the touch panel 2A and the display 2B in the front surface of the smartphone 1 as shown in FIG. 3. The solar panel 2D in one embodiment has a lattice-shaped structure so as not to block light emitted from a side of the display 2B but lead the light outside the housing 2C. The user can visually recognize the screen displayed on the display 2B through the protection panel 2E protecting an area around the display 2B, the transparent touch panel 2A and solar panel 2D. The solar panel 2D needs to transparently transmit at least part of the light emitted from the side of the display 2B.

The configuration of the smartphone 1 is not necessarily limited to the configuration described above. The solar panel 2D may be located on an outer side of the touch panel 2B, and the display 2B having transparency may be located on an outer side of the solar panel 2D. The smartphone 1 may include members other than the members described above in the various area. The configuration of locating the touch panel 2A on the outer side of the solar panel 2D enables the inhibition of a damage of the solar panel 2D. If the touch panel 2A is located on the further front surface, a detection sensitivity of the touch panel 2A on a finger is increased.

In the solar panel 2D according to one embodiment, an absorption wavelength is adjusted to generate the electrical power with high efficiency particularly at a time of receiving the solar light. However, a solar panel having similar characteristics needs not necessarily be used as the solar panel 2D. For example, the solar panel 2D may be transparent to absorb mainly invisible light in an ultraviolet region or an infrared region and transparently transmit visible light.

In one embodiment, the solar panel 2D is disposed in a position to overlap with the display 2B, however, an area of the solar panel 2D needs not necessarily be the same as the area of the display 2B or the touch panel 2A. Also applicable is a structure that the solar panel 2D has an area large enough to cover a wider range of the smartphone 1 than the display 2B and the touch panel 2A. The solar panel 2D may have a small area to cover only part of the display 2B. The smartphone 1 may comprise one solar panel 2D or the plurality of solar panels 2D. The solar panel 2D may be located on the side surface or the back surface of the smartphone 1. The solar panel 2D needs not necessarily overlap with the display 2B. The solar panel 2D may be located on a bezel surrounding the display 2B. In the smartphone 1, a power generation unit having a thin linear shape to generate the electrical power using the light may be applied instead of the solar panel 2D.

The electrical power generated by the solar panel 2D can also be supplied to the backlight LED 2F in the display 2B as well as being used for charging the battery 4. In supplying the electrical power from the solar panel 2D to the LED 2F, the solar panel 2D and the LED 2F may be directly connected to each other, or may be connected via various circuits such as a booster circuit or electronic components. For example, a plate-shaped LED may be used as the LED 2F, or a large number of spherical LEDs may also be used.

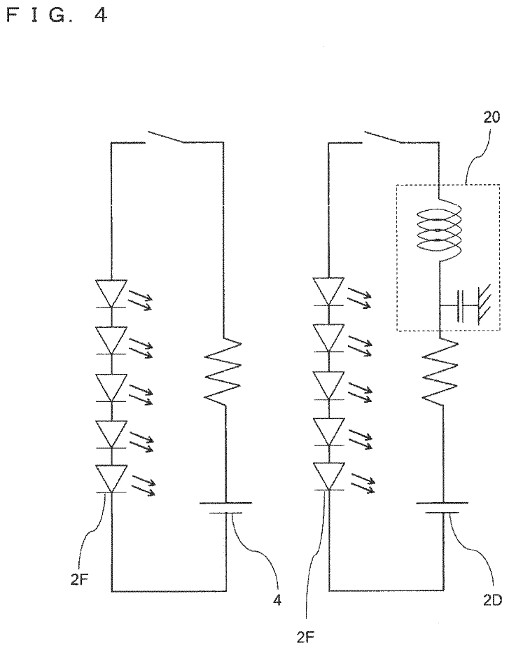

When the smartphone 1 is used outdoors on a sunny day, a light volume from the sun increases, and the light entering eyes of the user increases. As a result, emission intensity of the LED included in the display as the backlight is relatively reduced, thus the visibility of the display decreases. However, as indicated by the circuit diagram in FIG. 4, the smartphone 1 comprises the LED 2F to which the electrical power is directly supplied from the solar panel 2D and the LED 2F to which a certain amount of electrical power is supplied from the battery 4 as the backlight of the display 2B. According to the above configuration, when the smartphone 1 is used outdoors during daytime, a power generation amount of the solar panel 2D increases and the larger amount of electrical power is supplied to the backlight LED 2F, thus the screen is illuminated more brightly. In the meanwhile, when the smartphone 1 is used indoors and during night-time, the power generation amount of the solar panel 2D decreases, and the screen is mainly illuminated by the LED 2F to which the electrical power is supplied from the battery 4.

According to the above configuration, a discharge and charge of the battery 4 is reduced compared to a case where all of the electrical power is supplied by the battery 4, thus a heat generation is reduced in the battery 4. Furthermore, there is no occurrence of a heat generation accompanied with a pressure rising which is necessary to supply the electrical power from the battery 4 to the various units of the smartphone 1. Thus, not only a consumption of the battery 4 is reduced, but also the heat generation in the battery 4 and booster circuit in the smartphone 1 is reduced, and moreover, sufficient visibility of the display 2B can also be ensured. Furthermore, according to the configuration of one embodiment, luminance of the screen is adjusted by measuring the power generation amount of the solar panel 2D without an illuminance sensor, which is included in a conventional smartphone, for measuring surrounding luminance to adjust luminance of the screen. Accordingly, a downsizing and designability of a terminal such as particularly a watch type terminal which is small in size and hardly has a space for the illuminance sensor are not lost, but the terminal can adjust the luminance of the screen in accordance with a surrounding environment.

Concerned in the above configuration is that the luminance of the screen frequently changes due to a change in the power generation amount when the posture of the smartphone 1 changes, thereby an incident angle of the solar light entering the solar panel 2D changes and the smartphone 1 temporarily goes in shadow, for example. Applicable as a means of resolving the above problem is a voltage-current fluctuation reduction circuit 20 including an electricity storage (such as a capacitor) and a coil, for example, in a pathway between the solar panel 2D and the LED 2F. According to the above configuration, the change in the voltage and current is reduced, and the luminance of the screen becomes stable.

The smartphone 1 may include the other circuit for determining whether or not the electrical power is supplied based on monitoring of at least one of a charge state and a temperature.

### Second Embodiment

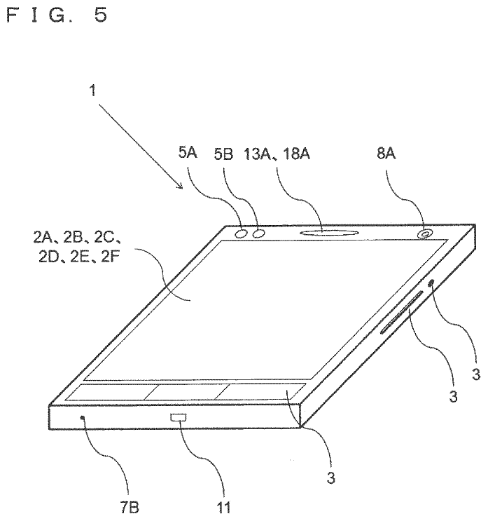

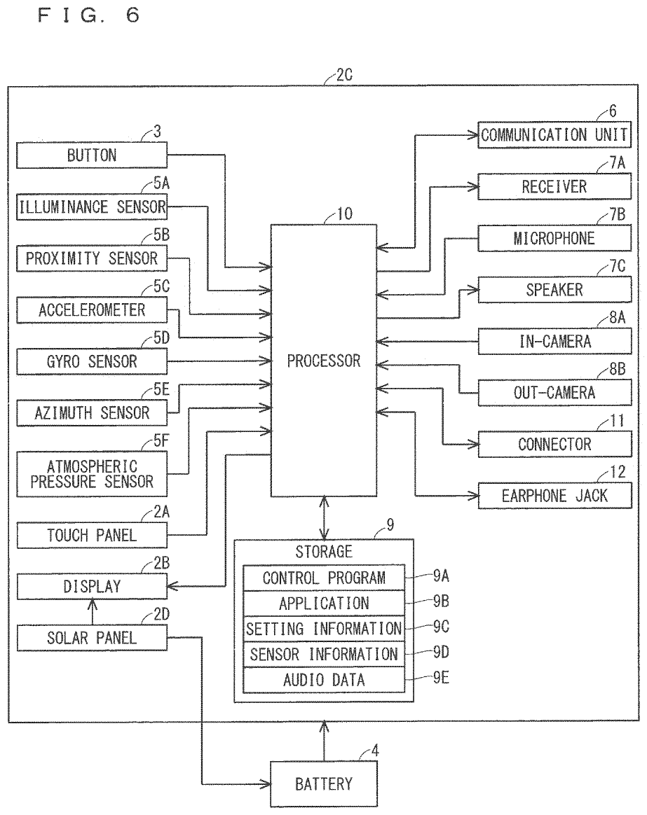

A configuration of the smartphone 1 according to one embodiment is described based on FIG. 5 and FIG. 6. A description of a configuration in the smartphone 1 of one embodiment in common with that in the first embodiment is omitted. The smartphone 1 according to one embodiment comprises an illuminance sensor 5A in addition to the configuration of the smartphone 1 according to the first embodiment.

In one embodiment, the display 2B includes the LED 2F receiving the power supply from battery 4 and the LED 2F receiving the electrical power from the solar panel 2D. The electrical power amount supplied from the battery 4 to the former LED 2F is controlled based on a signal of the illuminance sensor 5A as described below. Since the latter LED 2F receives the power supply from the solar panel 2D, the electrical power amount supplied to the latter LED 2F changes in accordance with an intensity of solar light which the solar panel 2D receives.

The illuminance sensor 5A is used to detect surrounding illuminance and control the luminance of the display 2B. The illuminance sensor 5A can measure the illuminance of an indoor lightning with higher sensitivity than the solar panel 2D. If the illuminance detected by the illuminance sensor 5A is large, the processor 10 sets the display 2B bright to increase the visibility of the display 2B. That is to say, the processor 10 supplies the larger amount of current from the battery 4 to the LED 2F.

According to the above configuration, the luminance of the LED 2F receiving the power supply from the battery 4 based on the signal being output from the illuminance sensor SA changes, thus the luminance of the screen of the display 2B is adjusted more appropriately even indoors. The intensity of the signal of the conventional illuminance sensor fluctuates in a case where the illuminance is extremely high, so that an accurate measuring of the illuminance is hard. However, the accurate measuring of the illuminance can be performed even in a high illuminance state by measuring the electrical power amount of the solar panel 2D. In adjusting the luminance of the screen performed only by the illuminance sensor SA, the luminance of the screen is uniformly set to maximum if the illuminance is equal to or larger than a certain level, so that it is hard to appropriately control the luminance outdoors during daytime on a sunny day or in a cloudy day, for example. In contrast, according to the present configuration, the solar panel 2D can determine whether it is bright or dark outdoors in addition to the determination whether it is bright or dark indoors performed by the illuminance sensor SA, thus the luminance of the screen can be controlled more appropriately even on a cloudy day or in a sunny day, for example. Moreover, according to the configuration of one embodiment, the battery 4 does not cover all of the power supply to the LED 2F when the smartphone 1 is used outdoors, thus the heat generation in the smartphone 1 and the consumption of the battery 4 are reduced.

If the smartphone 1 comprises a plurality of displays, the luminance of the screens of the plurality of displays may be uniformly the same in the processing described above. Alternatively, the luminance of the screen may be managed for each display to vary the luminance of the screen of each of the plurality of displays.

The proximity sensor 5B may double as the function of the illuminance sensor 5A.

### Third Embodiment

One embodiment of controlling the luminance of the screen using the various sensors is described hereinafter. The description of the configuration described in the first embodiment or the second embodiment is omitted.

The first embodiment and the second embodiment describe that the screen is brightened when the smartphone 1 is used outdoors in accordance with the power generation amount of the solar panel 2D. The light volume of the solar light received by the solar panel 2D and the power generation amount also depend on the incident angle of the solar light entering the solar panel 2D. Accordingly, the amount of the power supply from the battery 4 to the LED 2F may be controlled in accordance with the incident angle.

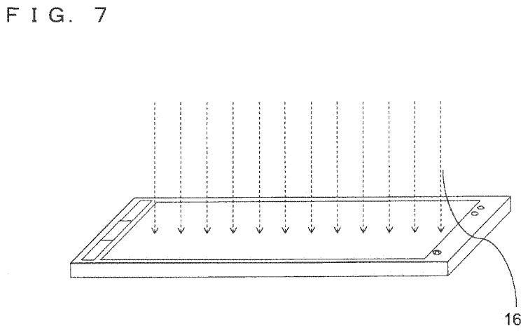

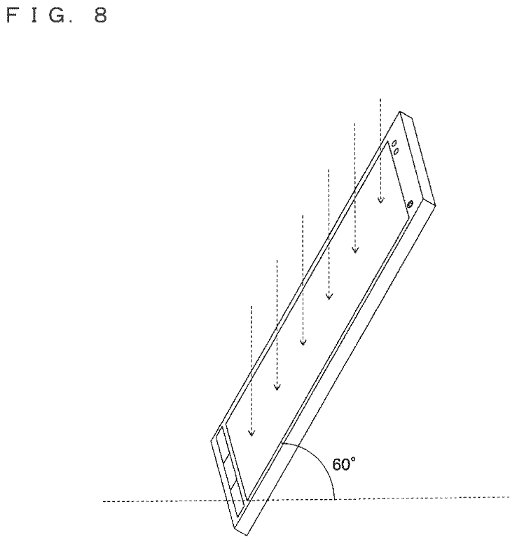

FIG. 7 and FIG. 8 indicate the solar light entering the solar panel 2D by arrows.

FIG. 7 shows a state where solar light 16 enters at right angle with the solar panel 2D. FIG. 8 shows a state where the solar light 16 enters the solar panel 2D at the incident angle of 60 degrees. There is no difference in the surrounding luminance in FIG. 7 and FIG. 8. The arrows each indicating the solar light 16 are illustrated at regular intervals. In FIG. 8, the illuminance on the surface of the solar panel 2D (luminous flux per unit of area) is approximately half as much as that of a case in FIG. 7. Thus, the electrical power amount in the solar panel 2D shown in FIG. 8 is smaller than the electrical power amount in the solar panel 2D shown in FIG. 7. Accordingly, if all of the electrical power obtained by the solar panel 2D is supplied as in the case of the first embodiment, the smartphone 1 in the posture in FIG. 8 has the luminance of the screen lower than that in FIG. 7 even though there is no difference in the surrounding luminance, so that the user may have difficulty in seeing the display 2B when the smartphone 1 has the posture in FIG. 8.

The accelerometer 5C, the gyro sensor 5D, and the azimuth sensor 5E and GPS, for example, may be used to solve the above problem. The processor 10 can specify the posture of the smartphone 1, that is to say, the posture of the solar panel 2D based on the output signal of the accelerometer 5C and the gyro sensor 5D. The processor 10 can specify a current position of the smartphone 1 based on the position information obtained by the GPS, for example, and can estimate an incident direction or an incident angle of the solar light based on the specified current position, the specified posture, the output signal of the azimuth sensor 5E, and a current time. A rough position of the smartphone 1 needs to be specified, thus position information of a base station or an access point to which the communication unit 6 is connected may be used as the position information of the smartphone 1.

The incident angle or the incident direction of the solar light entering the solar panel 2D can be estimated by using these pieces of information. The processor 10 may obtain a power generation efficiency of the solar panel 2D from the estimated incident angle or incident direction, and adjust the luminance of the screen based on the obtained power generation efficiency. For example, if the processor 10 estimates that the incident angle of the solar light changes from the state in FIG. 7 to the state in FIG. 8, the processor 10 may estimate that the power generation efficiency of the solar panel 2D is reduced to half. If the luminance of the screen is appropriately adjusted in accordance with the luminance around the smartphone 1 in the power generation efficiency of the solar panel 2D in the state in FIG. 7, it is considered that the luminance of the screen is not appropriate for the luminance around the smartphone 1 in a state where the power generation efficiency is reduced as in the case of FIG. 8, for example. At this time, the processor 10 may increase the amount of the electrical power supplied from the battery 4 to make up for the power generation amount of the solar panel 2D reduced in accordance with the reduction in the power generation efficiency and keep a total amount of emission substantially constant, thereby stabilizing the luminance of the screen. That is to say, if the processor 10 estimates that the smartphone 1 is in the state in FIG. 8, the processor 10 may make the battery 4 supply the electrical power amount which is equal to the amount of the electrical power generated by the solar panel 2D so that the electrical power amount in FIG. 8 coincides with the amount of the electrical power supplied from the solar panel 2D to the backlight LED 2F in the state in FIG. 7. According to the processing described above, the electrical power amount equal to that in the state in FIG. 7 is supplied to the backlight LED 2F, and the luminance of the screen is appropriately controlled also in the state in FIG. 8. Alternatively, the processor 10 may set an upper limit value on the amount of the electrical power supplied from the solar panel 2D to the backlight LED 2F so as not to unnecessarily brighten the screen too much in the case where the solar light enters at right angle, thereby stabilizing the luminance of the screen.

The processor 10 may perform the control in accordance with only the posture, for example. The light is often generally emitted from an upper side. Accordingly, if the posture makes a transition from the state where the smartphone 1 is horizontally disposed as in the case of FIG. 7 to the state where the smartphone 1 is obliquely disposed as in the case of FIG. 8, for example, the power generation efficiency is considered to be reduced. At this time, the processor 10 may increase the amount of the electrical power supplied from the battery 4.

The above example describes that the smartphone 1 considers the change in the incident direction of the solar light from the posture of the smartphone 1 and the time. The processor 10 of the smartphone 1 may estimate an optic element of the solar light using one or some of a period of time, position information, and weather information obtained from Internet, for example, and obtain the power generation efficiency based on the estimated result.

For example, the processor 10 may estimate the optic element of the solar light based on the period of time. The light emitted from the sun has a red component with a high degree in an early-morning period or an early-evening period. If the solar panel 2D is designed to generate the electrical power with highest efficiency upon receiving a blue component of the light, the power generation amount of the solar panel 2D is small relative to the surrounding luminance when the light emitted from the sun has the red component of the light with the high degree. Accordingly, there is a possibility that the screen is not sufficiently illuminated in the early-morning period or the early-evening period. Thus, in the early-morning period or the early-evening period, the processor 10 may increase the amount of the electrical power supplied from the battery 4 to the backlight LED 2F by the amount of the electrical power which is considered to be insufficient in accordance with the reduction in the power generation efficiency of the solar panel 2D.

For example, the processor 10 may estimate the optic element of the solar light based on the weather information of the current position. If the weather information of the current position indicates the cloudy weather, the solar light tends to have an optic element of short wavelength with a low degree and long wavelength with a high degree, thus if the solar panel 2D is designed to generate the electrical power with high efficiency upon receiving the light having the short wavelength, the power generation amount of the solar panel 2D is small relative to the surrounding luminance. Accordingly, if the weather is the cloudy, the processor 10 may increase the amount of the electrical power supplied from the battery 4 to the backlight LED 2F.

For example, the processor 10 may execute the control in accordance with the period of time described above and the control in accordance with the weather information of the current position in combination with each other. For example, in the early-morning period or the early-evening period, if the weather in the current position is cloudy, the processor 10 may further increase the amount of the electrical power supplied from the battery 4 to the backlight LED 2F.

### Fourth Embodiment

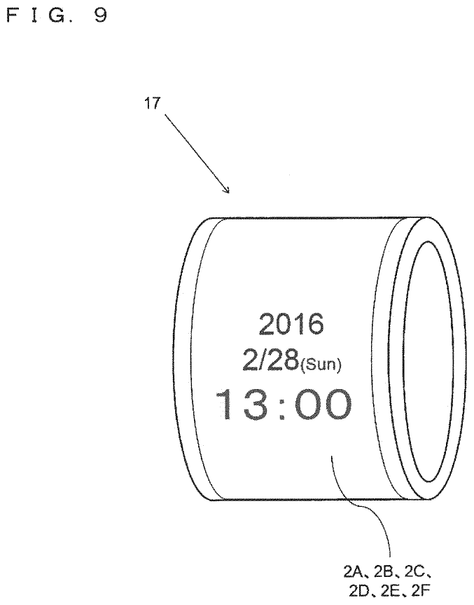

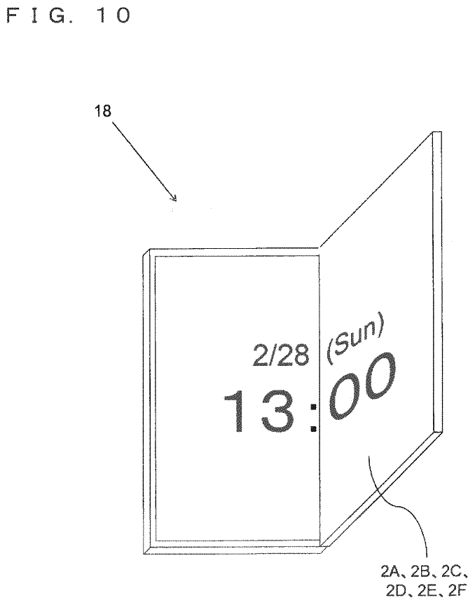

In one embodiment, a terminal having a special shape other than a smartphone is described. In a bracelet type terminal 17 having a curved surface display shown in FIG. 9 and a folding terminal 18 having a flexible display shown in FIG. 10, for example, a way of the solar light reaching the various units of the solar light panel 2D changes depending on a position of the display 2B and a state of the terminal. As a result, a way of the solar light reaching the various units of the screen changes depending on the position of the display 2B and the state of the terminal.

In this case, the processor 10 may set the luminance of an area in the screen which the solar light reaches bright, and set the luminance of an area in the screen which the solar light does not reach dark.

According to the above configuration, even if the terminal has the plurality of displays in the surfaces in using the terminal, the terminal needs not include the illuminance sensor in each surface. In the similar manner, even the terminal having the curved shape display needs not include the plurality of illuminance sensors in various areas.

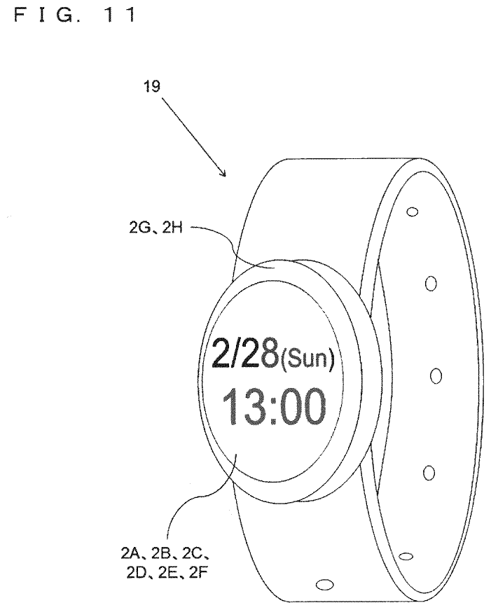

For example, a watch type terminal 19 shown in FIG. 11 may comprise the solar panel 2D overlapping with the display 2B to generate the electrical power with high efficiency using the solar light and another solar panel 2H located in a bezel 2G, which surrounds the display 2B, to generate the electrical power with high efficiency using the light of indoor lightning. The solar panel 2D and the solar panel 2H may overlap with each other to be located in the same position.

The above configuration enables the power generation performed by the solar panel 2D or the solar panel 2H even outdoors or indoors. Moreover, the luminance of the screen can be changed outdoors in accordance with the power generation amount of the solar panel 2D located to overlap with the display 2B, and the luminance of the screen can be appropriately changed indoors in accordance with the power generation amount of the solar panel 2H. Furthermore, there is no need to provide a region for the illuminance sensor in a part of the display 2B or the bezel 2G of the watch type terminal 19 having a limited area, thus the above configuration contributes to the downsizing of the terminal.

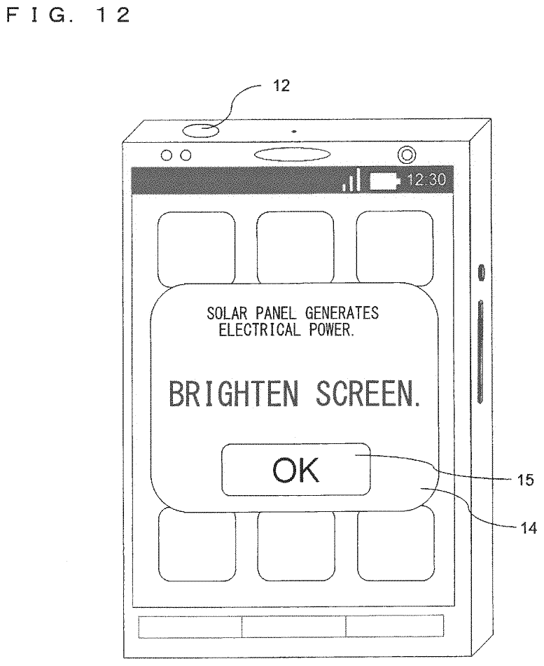

The control of the backlight LED 2F in the liquid crystal display is described above. The processing described above may be performed constantly, or may be executed in accordance with the operation performed by the user, for example. The charging of the battery 4 may have a priority over the brightening of the screen depending on the user or the state. Thus, it is applicable to display a pop-up window 14 shown in FIG. 12 and brighten the screen with user's approval. The pop-up window 14 includes an OK button 15. If the OK button 15 is operated, the screen is brightened. The screen may be brightened in accordance with the setting which has been previously performed on the smartphone 1. A past history of a change in battery charge remaining, a usage history of CPU, or a history of lighting time of a display, for example, is checked, and if it can be specified from the checked history that the period of time when the user uses the smartphone 1 is concentrated in a night-time, all or part of the electrical power obtained by the solar panel 2D may be used for charging the battery 4 to prepare for the usage of the smartphone 1 in the night-time. It is also applicable to give priority to the charging of the battery 4, in a similar manner, in a case where it is expected from the weather information obtained from Internet, for example, that the electrical power cannot be sufficiently obtained from the solar light for a while afterwards.

If the luminance of the screen can be sufficiently obtained by the LED 2F which receives a certain amount of the electrical power from the battery 4, part of the electrical power obtained by the solar panel 2D may be used for charging the battery 4. If there is a possibility of damaging the LED 2F due to an excess supply of the electrical power to the LED 2F, part of the electrical power obtained by the solar panel 2D may be used for charging the battery 4. Also in a case where the screen display is not performed such as a sleep mode and a shut-down mode, for example, the electrical power obtained by the solar panel 2D may be used for charging the battery 4.

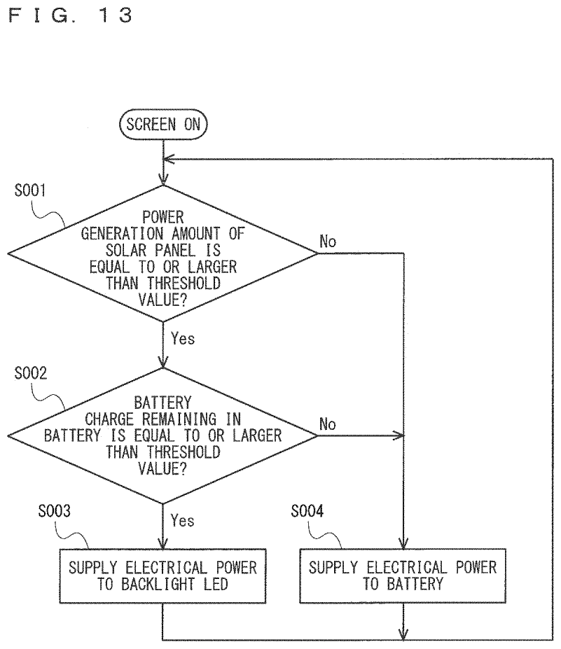

The power supply from the solar panel 2D may be controlled in accordance with a flow shown in FIG. 13, for example. In the flow in FIG. 13, the processor 10 firstly determines whether or not the power generation amount in the solar panel 2D exceeds a threshold value in Step S001. If the power generation amount exceeds the threshold value, the processor 10 confirms a battery charge remaining in the battery 4 by checking the voltage of the battery 4 next in Step S002. At this time, if the amount of the battery charge remaining in the battery 4 is equal to or larger than the threshold value, the processing proceeds to Step S003. In Step S003, the processor 10 supplies the electrical power from the solar panel 2D to the LED 2F. If the amount of the battery charge remaining is not equal to or larger than the threshold value in Step S001 or if the amount of the battery charge remaining is not equal to or larger than the threshold value in Step S002, the processor 10 uses the electrical power obtained by the solar panel 2D for charging the battery 4. In the manner similar to the flow described above, the supply destination of the electrical power from the solar panel 2D may be determined based on whether or not the smartphone 1 is in a state where the electrical power sufficient to brighten the screen can be obtained from the solar panel 2D and the battery charge remaining in the battery 4.

Although the control of the amount of the power supply to the LED 2F of the liquid crystal display is described above as one example, the display is not necessarily limited to the liquid crystal display. For example, if a self-luminous display such as an organic EL display is applied to the display, the emission intensity may be increased by controlling the power supply amount to brighten the screen in the similar manner. However, in the example described above, the change in the luminance of the screen cannot be so easily achieved as in the case of changing the luminance of the LED 2F of the liquid crystal display by increasing and decreasing the power generation amount of the solar panel 2D. In such a case, the luminance may be increased by changing a numerical value for determining the luminance of the screen in the terminal in accordance with the power generation amount of the solar panel 2D. Also in an in-car terminal and a glasses type terminal projecting an image onto a glass, for example, the visibility is similarly reduced in a bright surrounding environment, thus the luminance of the screen may be changed. In a case where the visibility is not reduced even if the emission intensity is reduced in the strong solar light such as a front-light type electronic paper, the electrical power supplied from the battery 4 may be reduced to reduce the luminance on the contrary.

Not only in the display but also in an LED used for the notification, for example, and an LED for making the button 3 emit the light, the luminance may be changed in accordance with the power generation amount of the solar panel. That is to say, the present disclosure can be applied to any type of terminal as long as it has a light emitting unit. An object which the solar panel 2D, which is a power generation unit, absorbs is not limited to the solar light. For example, the solar panel 2D may absorb light emitted from an LED used for indoor lightning with high efficiency.

The power generation unit which generates the electrical power upon receiving the solar light in the part of the terminal has been described, however, the whole housing 2C may be made up of a material which can generate the electrical power upon receiving the light. That is to say, at least a part of the terminal needs to have the function of generating the electrical power using the surrounding light. The control of brightening the screen may be performed by attaching an apparatus having the function of generating the electrical power using the light to the terminal afterward.

As described above, the smartphone 1 and the terminals having various special shapes have been described as the examples, however, the present disclosure can be applied similarly to another electronic device other than the smartphone 1. The present disclosure can be applied to, for example, a feature phone, a tablet terminal, a PDA, a digital camera, a music player, and a game machine.

The art of appended claims has been described with respect to specific embodiments for a complete and clear disclosure. However, the appended claims are not to be thus limited but are to be construed as embodying all modifications and alternative constructions that may occur to one skilled in the art which fairly fall within the basic teaching herein set forth.

1. An electronic device, comprising:
a rechargeable battery;
a display configured to be able to display a screen and change luminance of the screen; and
a power generation unit configured to generate electrical power upon receiving solar light, wherein
the display includes:
a first light emitting unit to which electrical power is supplied from the power generation unit to emit light; and
a second light emitting unit to which electrical power is supplied from the battery to emit light, and
changes a screen to be bright if electrical power supplied from the power generation unit becomes large, and darken the screen if the electrical power supplied from the power generation unit becomes small.

2. The electronic device according to claim 1, wherein
the power generation unit supplies at least part of electrical power being generated by the power generation unit to the display if the electrical power exceeds a threshold value, and
supplies the electrical power being generated by the power generation unit to the battery if the electrical power does not exceed a threshold value.

3. The electronic device according to claim 1, wherein
the electronic device does not include an illuminance detector measuring a surrounding luminance other than the power generation unit.

4. The electronic device according to claim 1, further comprising
a specifying unit configured to specify a posture of the electronic device, wherein
the luminance of the screen is controlled based on the posture and the electrical power being generated by the power generation unit.

5. The electronic device according to claim 1, further comprising
an acquisition unit configured to acquire at least one of a current time and weather information, wherein
the luminance of the screen is controlled based on the at least one of the current time and the weather information and the electrical power being generated by the power generation unit.

6. The electronic device according to claim 1, wherein
when the display does not display an image, the electrical power generated by the power generation unit is used to charge the battery.
